(19) United States
(12) Patent Application Publication
(10) Pub. No.: US 2025/0377628 A1
(43) Pub. Date: Dec. 11, 2025

(54) IMAGE FORMING APPARATUS

(71) Applicant: CANON KABUSHIKI KAISHA, Tokyo (JP)

(72) Inventors: KOJI NOJIMA, Chiba (JP); YOSHIMASA BANDO, Tokyo (JP)

(21) Appl. No.: 19/186,870

(22) Filed: Apr. 23, 2025

(30) Foreign Application Priority Data
Jun. 10, 2024 (JP) 2024-093482
Feb. 28, 2025 (JP) 2025-031439

(51) Int. Cl. G03G 21/20; G03G 15/20

(52) U.S. Cl. CPC G03G 21/206; G03G 15/2039; G03G 15/2064; G03G 2215/00413; G03G 2215/00721; G03G 2221/1639; G03G 2221/1642; G03G 2221/1645

(57) ABSTRACT

There is provided an image forming apparatus including: a second duct unit including a second intake port that sucks air between a fixing unit and a transfer unit, a second exhaust port that exhausts air sucked from the second intake port to the outside, and a second duct that forms a second ventilation passage between the second intake port and the second exhaust port; a second duct fan that is provided in the second ventilation passage and generates an air flow from the second intake port toward the second exhaust port; a filter that is provided in the second ventilation passage and removes fine particles; and a control unit that controls operations of a first duct fan and the second duct fan, in which, in a case where a continuous job is started, the control unit starts the operation of the first duct fan when a conveyance distance of a recording material passing through a fixing nip portion reaches a first predetermined value.

### BACKGROUND OF THE INVENTION

### Field of the Invention

The present invention relates to an image forming apparatus using an electrophotographic technology such as a printer, a copying machine, a facsimile, or a multifunction peripheral having a plurality of functions thereof.

### Description of the Related Art

In the related art, an image forming apparatus includes a fixing device that applies heat and pressure to a recording material on which a toner image is formed to fix the toner image on the recording material. Such a fixing device includes an endless heated fixing belt and a pressure roller that abuts against and pressurizes the fixing belt. The fixing device fixes the toner image on the recording material by nipping and conveying the recording material on which the toner image is formed while heating and pressurizing the recording material in the fixing nip portion formed by the fixing belt and the pressure roller.

Further, in Japanese Patent Application Laid-Open No. 2020-134935, a filter unit and an exhaust duct independent of the filter unit are disposed in the vicinity of the fixing device. The filter unit includes a filter, and the ultra fine particles (UFPs), which are ultra fine particles of several nm to several hundred nm generated by vaporization of wax as a release agent contained in the toner by heat, are collected from the air by the filter. In addition, the exhaust duct is used for exhausting heat and discharging water vapor generated by heating of the recording material, and does not include a ventilation resistor such as a filter in order to secure an air volume. As described above, the image forming apparatus in the related art includes the filter unit and the exhaust duct in order to achieve UFP reduction, heat exhaust, and water vapor discharge.

### SUMMARY OF THE INVENTION

According to the present invention, there is provided an image forming apparatus capable of executing a continuous job of forming an image on a plurality of recording materials, the image forming apparatus including: an image forming unit that forms a toner image using a toner containing a release agent; a transfer unit that performs a transfer operation of transferring the toner image formed by the image forming unit to a recording material; a fixing unit that includes a first rotating member that is heated by a heating unit and a second rotating member that abuts against the first rotating member and forms a fixing nip portion together with the first rotating member, and fixes the toner image to the recording material by nipping and conveying the recording material to which the toner image is transferred by the transfer unit at the fixing nip portion; a first duct unit including a first intake port that sucks air between the fixing unit and the transfer unit, a first exhaust port that exhausts air sucked from the first intake port to an outside, and a first duct that forms a first ventilation passage between the first intake port and the first exhaust port; a first duct fan that is provided in the first ventilation passage and generates an air flow from the first intake port toward the first exhaust port; a second duct unit including a second intake port that sucks air between the fixing unit and the transfer unit, a second exhaust port that exhausts air sucked from the second intake port to the outside, and a second duct that forms a second ventilation passage between the second intake port and the second exhaust port; a second duct fan that is provided in the second ventilation passage and generates an air flow from the second intake port toward the second exhaust port; a filter that is provided in the second ventilation passage and removes fine particles; and a control unit that controls operations of the first duct fan and the second duct fan, in which, in a case where a continuous job is started, the control unit starts the operation of the first duct fan when a conveyance distance of a recording material passing through the fixing nip portion reaches a first predetermined value.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to an embodiment of the present invention;

FIG. 2 is a block diagram illustrating a configuration of the image forming apparatus according to the embodiment of the present invention;

FIG. 3 is a schematic diagram of a part of the image forming apparatus according to the embodiment of the present invention;

FIG. 4 is a perspective view of a part of the image forming apparatus according to the embodiment of the present invention;

FIG. 5 is a perspective view of a duct unit of the image forming apparatus according to the embodiment of the present invention;

FIGS. 6A and 6B are diagrams illustrating a generation mechanism of UFP in the image forming apparatus according to the embodiment of the present invention, and a relationship of generation of UFP, a concentration of wax vapor, and a temperature of an internal space of the apparatus;

FIG. 7 is a diagram illustrating a relationship between time and an emission rate of the UFP in an operating state and a non-operating state of a second fan of the image forming apparatus according to the embodiment of the present invention;

FIGS. 8A and 8B are diagrams illustrating an operation time of the second fan of the image forming apparatus according to the embodiment of the present invention;

FIG. 9 is a diagram illustrating a relationship between time and the emission rate of the UFP in a case where the second fan of the image forming apparatus according to the embodiment of the present invention is operated, as compared with a case where the second fan is operated at all times;

FIG. 10 is a diagram illustrating a modification of the operation time of the second fan of the image forming apparatus according to the embodiment of the present invention;

FIG. 11 is a diagram illustrating a further modification of the operation time of the second fan of the image forming apparatus according to the embodiment of the present invention;

FIG. 12 is a block diagram illustrating a configuration of an image forming apparatus according to Embodiment 2 of the present invention;

FIG. 13 is a schematic diagram of a part of the image forming apparatus according to Embodiment 2 of the present invention;

FIGS. 14A and 14B are perspective views of a part of the image forming apparatus according to Embodiment 2 of the present invention;

FIGS. 15A and 15B are views illustrating an air flow of a duct unit of the image forming apparatus according to Embodiment 2 of the present invention;

FIGS. 16A, 16B, and 16C are diagrams illustrating operation times of a first fan, a first duct fan, and a second duct fan of the image forming apparatus according to Embodiment 2 of the present invention; and

FIG. 17 is a diagram illustrating a relationship between the time and the emission rate of the UFP in a case where the first duct fan of the image forming apparatus according to Embodiment 2 of the present invention is operated, as compared with a case where the first duct fan is operated at all times.

### DESCRIPTION OF THE EMBODIMENTS

Hereinafter, embodiments will be described in detail with reference to the drawings.

### Configuration of Image Forming Apparatus

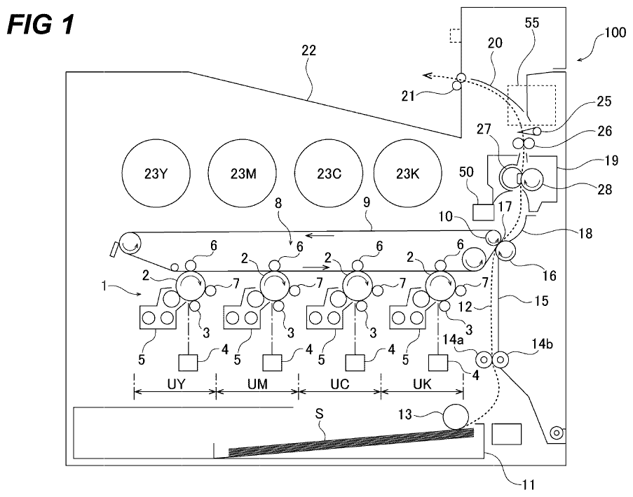

A configuration of an image forming apparatus 100 according to an embodiment of the present invention will be described in detail with reference to FIGS. 1 to 3.

Here, the image forming apparatus 100 is exemplified by a tandem-intermediate transfer-type four-color full-color laser printer using an electrophotographic process. The image forming apparatus 100 forms an image on a sheet S as a recording material based on image information input from an input device B such as a personal computer to a control circuit portion A. Note that the image forming apparatus 100 is a color electrophotographic apparatus such as a color copying machine including a plurality of photosensitive drums, but is not limited thereto, and may be a monochrome electrophotographic apparatus such as a monochrome copying machine or a printer including one photosensitive drum.

Specifically, the image forming apparatus 100 includes an image forming portion 1, a belt suspension roller 10, a sheet feeding roller 13, a registration roller 14a, a registration roller 14b, a guide member 15, and a secondary transfer roller 16. The image forming apparatus 100 includes a guide member 18, a fixing device 19, a guide member 20, a discharge roller pair 21, a discharge tray 22, toner bottles 23Y, 23M, 23C, and 23K, a detection sensor 25, and a discharge roller pair 26. The image forming apparatus 100 further includes a duct unit 50, a first fan 55, a sheet member 59, an in-machine temperature sensor 65, and the control circuit portion A.

The image forming portion 1 as an image forming unit forms a toner image using a toner containing a release agent. The image forming portion 1 includes a first image forming unit UY, a second image forming unit UM, a third image forming unit UC, a fourth image forming unit UK, an intermediate transfer belt unit 8, and a sheet cassette 11.

The first image forming unit UY forms a yellow (Y) toner image.

The second image forming unit UM forms a magenta (M) toner image.

The third image forming unit UC forms a cyan (C) toner image.

The fourth image forming unit UK forms a black (K) toner image.

Each of the first image forming unit UY, the second image forming unit UM, the third image forming unit UC, and the fourth image forming unit UK includes a drum 2, a charging roller 3, a laser scanner 4, a development device 5, a primary transfer roller 6, and a drum cleaner 7.

The drum 2 is rotated by driving of a driving device (not illustrated).

The charging roller 3 uniformly charges the front surface of the drum 2.

The laser scanner 4 forms an electrostatic latent image on the drum 2 by irradiating the drum 2 charged by the charging roller 3 with a laser based on image information input from the input device B.

The development device 5 forms a toner image on the drum 2 by supplying a toner to the drum 2 on which an electrostatic latent image is formed by the laser scanner 4.

The primary transfer roller 6 is provided inside the intermediate transfer belt 9 of the intermediate transfer belt unit 8, and is in pressure contact with the drum 2 via the intermediate transfer belt 9. The primary transfer roller 6 sequentially primarily transfers the toner image formed on the drum 2 to the intermediate transfer belt 9.

The drum cleaner 7 removes the toner remaining on the drum 2 without being primarily transferred to the intermediate transfer belt 9 by the primary transfer roller 6 from the drum 2 and collects the toner.

The intermediate transfer belt unit 8 is provided above the first image forming unit UY, the second image forming unit UM, the third image forming unit UC, and the fourth image forming unit UK, and includes the intermediate transfer belt 9.

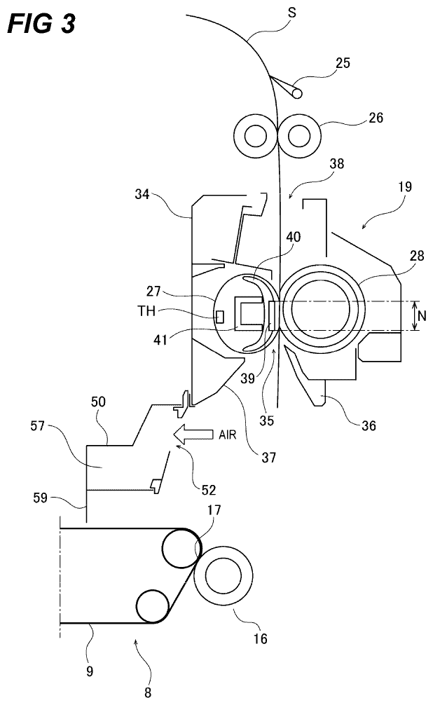

The intermediate transfer belt 9 as a belt member is rotated in the counterclockwise direction in FIGS. 1 and 3 by driving of a driving device (not illustrated). On the intermediate transfer belt 9, toner images of four colors of Y, M, C, and K are superimposed and primarily transferred from each of the first image forming unit UY, the second image forming unit UM, the third image forming unit UC, and the fourth image forming unit UK by the primary transfer roller 6. The intermediate transfer belt 9 rotates to convey the primarily transferred toner image.

The sheet cassette 11 is provided below the first image forming unit UY, the second image forming unit UM, the third image forming unit UC, and the fourth image forming unit UK.

The intermediate transfer belt 9 is suspended on the belt suspension roller 10.

The sheet feeding roller 13 is driven at a predetermined control timing to separate the sheets S housed in the sheet cassette 11 one by one and feed the sheets S to the registration roller 14a and the registration roller 14b via the conveyance path 12.

The registration roller 14a and the registration roller 14b constitute a registration roller pair. After temporarily stopping the conveyance of the sheet S fed by the sheet feeding roller 13, the registration roller 14a and the registration roller 14b convey the sheet S to a secondary transfer nip portion 17 at a predetermined control timing.

The guide member 15 is provided between the registration roller 14a and the registration roller 14b and the secondary transfer roller 16. The guide member 15 guides conveyance of the sheet S conveyed between the registration roller 14a and the registration roller 14b of the conveyance path 12 and the secondary transfer roller 16.

The secondary transfer roller 16 as a transfer unit abuts against the belt suspension roller 10 with a predetermined pressing force via the intermediate transfer belt 9 to form the secondary transfer nip portion 17 together with the intermediate transfer belt 9. In the secondary transfer nip portion 17, the secondary transfer roller 16 performs a transfer operation of secondarily transferring the superimposed toner images of the four colors, which are primarily transferred onto the intermediate transfer belt 9, collectively to the sheet S conveyed by the registration roller 14a and the registration roller 14b. The secondary transfer roller 16 conveys the sheet S on which the toner image is secondarily transferred, to the fixing device 19.

The guide member 18 is provided between the secondary transfer roller 16 and the fixing device 19. The guide member 18 guides conveyance of the sheet S conveyed between the secondary transfer roller 16 and the fixing device 19 on the conveyance path 12.

The fixing device 19 as a fixing unit is a belt-heating type on-demand fixing device, and has a vertical path configuration that conveys the sheet S from the lower side to the upper side in the direction of gravity. Note that the fixing device 19 is not limited to the vertical path configuration, and may have a horizontal path configuration for conveying the sheet S in the horizontal direction.

The fixing device 19 performs heat-fixing processing of applying heat and pressure at the fixing nip portion N to the toner image, which is secondarily transferred to the sheet S conveyed from the secondary transfer nip portion 17 by the secondary transfer roller 16, to fix the toner image on the sheet S. The fixing device 19 conveys the sheet S, on which the toner image is fixed, to the discharge roller pair 26. Note that details of the configuration of the fixing device 19 will be described later.

The guide member 20 is provided between the fixing device 19 and the discharge roller pair 21. The guide member 20 guides conveyance of the sheet S conveyed between the fixing device 19 and the discharge roller pair 21 on the conveyance path 12.

The discharge roller pair 21 discharges the sheet S conveyed by the discharge roller pair 26 to the discharge tray 22.

The sheet S is discharged to the discharge tray 22 by the discharge roller pair 21.

The toner bottles 23Y, 23M, 23C, and 23K are detachably attachable and replaceable, and house replenishment toners for the development device 5. Each of the toner bottles 23Y, 23M, 23C, and 23K appropriately supplies an appropriate amount of toner at an appropriate timing to the development devices 5 of each of the image forming units UY, UM, UC, and UK by a toner supply mechanism (not illustrated).

The detection sensor 25 as a recording material detection unit is provided downstream of the discharge roller pair 26 in the conveyance direction (hereinafter simply referred to as a “conveyance direction”) of the sheet S. The detection sensor 25 detects the sheet S conveyed from the discharge roller pair 26 to the discharge roller pair 21, and outputs an electric signal corresponding to the detection result to the control circuit portion A.

The discharge roller pair 26 is provided downstream of the fixing device 19 in the conveyance direction, and conveys the sheet S conveyed by the fixing device 19 to the discharge roller pair 21.

The duct unit 50 sucks air between the fixing device 19 and the intermediate transfer belt 9 and air between the fixing device 19 and the secondary transfer roller 16 and discharges the air to the outside of the image forming apparatus 100.

Details of the configuration of the duct unit 50 will be described later.

The first fan 55 is disposed on the downstream side in the conveyance direction of the fixing device 19. The first fan 55 operates under the control of the control circuit portion A to collect and discharge water vapor floating on the downstream side in the conveyance direction of the fixing device 19.

The sheet member 59 is provided in the duct unit 50 to assist prevention of advection of water vapor contained in the sheet S to the intermediate transfer belt unit 8. The sheet member 59 extends from the duct unit 50 toward the intermediate transfer belt 9 on the downstream side of the secondary transfer nip portion 17 in the conveyance direction of the toner image by the intermediate transfer belt 9 (refer to FIG. 3).

The in-machine temperature sensor 65 as a temperature detection unit measures a space temperature (hereinafter simply referred to as “space temperature”) in the vicinity of a sheet inlet portion 35 (described later) of the duct unit 50 and around the fixing device 19, and outputs an electric signal corresponding to the measured space temperature to the control circuit portion A.

The control circuit portion A as a control unit controls the entire operation of the image forming apparatus 100 based on the image information input from the input device B. The control circuit portion A controls power supplied to a fixing heater 39 (described later) of the fixing device 19 to keep a temperature indicated by an electric signal input from a thermistor TH (described later) of the fixing device 19 at a target temperature, and adjusts a temperature detected by the thermistor TH to a predetermined target temperature. The control circuit portion A controls the operation of a second fan 56 (described later) of the duct unit 50 based on the detection result of the sheet S indicated by the electric signal input from the detection sensor 25 and the space temperature indicated by the electric signal input from the in-machine temperature sensor 65.

The conveyance path 12 for conveying the sheet S from the bottom to the top is provided on the right side in FIG. 1 inside the image forming apparatus 100 having the above configuration. The sheet feeding roller 13, the registration roller 14a and the registration roller 14b, the secondary transfer roller 16, the fixing device 19, and the discharge roller pair 21 and the discharge roller pair 26 are provided in this order from the lower side to the upper side of the conveyance path 12.

### Configuration of Fixing Device

A configuration of the fixing device 19 of the image forming apparatus 100 according to the embodiment of the present invention will be described in detail with reference to FIGS. 1, 3, and 4.

The fixing device 19 includes a fixing belt 27, a pressure roller 28, a housing 34, a fixing heater 39, a heater holder 40, a rigid stay 41, and the thermistor TH.

The fixing belt 27 as a first rotating member is in pressure contact with the pressure roller 28 at the fixing nip portion N, and when the pressure roller 28 is rotationally driven, a driving force is transmitted from the pressure roller 28 by a frictional force with the pressure roller 28, and the fixing belt 27 rotates following the pressure roller 28 in a counterclockwise direction in FIG. 3.

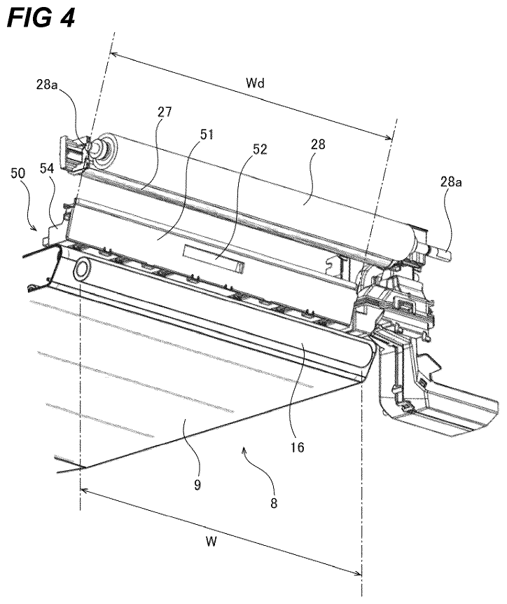

The pressure roller 28 as the second rotating member is a roller having elasticity, and includes a core metal 28a (refer to FIG. 4). As illustrated in FIG. 4, both end portions of the pressure roller 28 in the longitudinal direction of the core metal 28a are rotatably held by bearings (not illustrated). The pressure roller 28 has one end portion of the core metal 28a connected to a drive mechanism including a motor which is a drive source (not illustrated), and is rotationally driven at a predetermined circumferential velocity in a clockwise direction in FIG. 3 via the core metal 28a by driving of the motor.

In the pressure roller 28, the fixing belt 27 is pressed and the elastic rubber layer on the surface is elastically deformed to have a shape following the surface of the fixing heater 39, and accordingly, a fixing nip portion N having a predetermined width is formed between the pressure roller 28 and the fixing belt 27.

The fixing belt 27 and the pressure roller 28 nip and convey the sheet S bearing the unfixed toner image at the fixing nip portion N, and fix the toner image on the sheet S by heat and pressure.

The housing 34 houses the fixing belt 27 and the pressure roller 28. The housing 34 includes the sheet inlet portion 35, a first guide member 36, a second guide member 37, and a sheet outlet portion 38.

The sheet inlet portion 35 is formed by the first guide member 36 and the second guide member 37. The sheet inlet portion 35 is positioned below the sheet outlet portion 38 in the direction of gravity. The sheet inlet portion 35 is an inlet of the fixing device 19 when the sheet S is conveyed from the secondary transfer roller 16 to the fixing device 19.

The first guide member 36 faces the back surface of the sheet S which is the toner image non-bearing surface of the sheet S.

The second guide member 37 faces the front surface of the sheet S which is the toner image bearing surface of the sheet S.

The sheet outlet portion 38 is an outlet of the fixing device 19 when the sheet S is conveyed to the discharge roller pair 26 by the fixing belt 27 and the pressure roller 28.

The fixing heater 39 as a heating unit is provided inside the fixing belt 27. The fixing heater 39 is a heating source that heats the fixing belt 27 and is a pressing member that presses the fixing belt 27 toward the pressure roller 28. The fixing heater 39 is, for example, a ceramic heater. The fixing heater 39 is disposed along the rotation axial direction of the fixing belt 27 with the rotation axial direction of the fixing belt 27 as a longitudinal direction, and slidably abuts against the inner surface of the fixing belt 27. The fixing heater 39 generates heat and sharply increases in temperature when power is supplied from a power supply unit (not illustrated) under the control of the control circuit portion A.

The heater holder 40 is provided inside the fixing belt 27. The heater holder 40 is a member that holds the fixing heater 39 along the longitudinal direction of the fixing heater 39. The heater holder 40 fixes the fixing heater 39 toward the pressure roller 28 such that the fixing heater 39 and the inner surface of the fixing belt 27 are in contact with each other. The heater holder 40 serves as a guide member that guides formation of the circumferential curvature shape of the fixing belt 27 to facilitate separation of the sheet S from the fixing belt 27. The heater holder 40 desirably has excellent heat resistance, and for example, a liquid crystal polymer resin can be used.

The rigid stay 41 is provided inside the fixing belt 27. The rigid stay 41 is a support member that is provided along the longitudinal direction of the heater holder 40 and the fixing heater 39 and supports the heater holder 40 and the fixing heater 39. Both end portions of the rigid stay 41 in the longitudinal direction are pressurized toward the pressure roller 28 by a pressure mechanism (not illustrated).

The thermistor TH is provided inside the fixing belt 27. The thermistor TH detects the temperature of the fixing belt 27 and outputs an electric signal corresponding to the detected temperature to the control circuit portion A.

In the fixing device 19 having the above configuration, the pressure roller 28 is rotationally driven, and the temperature detected by the thermistor TH is adjusted to a predetermined target temperature by the control circuit portion A. In this state, the sheet S to which the unfixed toner image is transferred by the secondary transfer nip portion 17 is conveyed to the fixing device 19 via the sheet inlet portion 35. The toner image is fixed on the sheet S conveyed to the fixing device 19. Then, the sheet S on which the toner image is fixed is discharged from the sheet outlet portion 38.

### Configuration of Duct Unit

A configuration of the duct unit 50 of the image forming apparatus 100 according to the embodiment of the present invention will be described in detail with reference to FIGS. 1 and 3 to 5.

The duct unit 50 includes a plate member 51, an intake port 52, an exhaust port 53, a base member 54, a second fan 56, and a duct 57.

The plate member 51 has a flat plate shape and is attached to the base member 54.

The intake port 52 is provided near a central portion of the plate member 51 in the longitudinal direction parallel to the rotation axial direction of the fixing belt 27 (direction orthogonal to the paper surface in FIG. 3). The intake port 52 is provided on the fixing belt 27 side with respect to the conveyance path 12 of the sheet S between the secondary transfer roller 16 and the fixing device 19. The intake port 52 takes air between the fixing device 19 and the intermediate transfer belt 9 and air between the fixing device 19 and the secondary transfer roller 16, which are sucked by the second fan 56, into the duct 57.

The exhaust port 53 exhausts air sucked and taken into the duct 57 via the intake port 52 by the second fan 56 to the outside of the image forming apparatus 100.

The length Wd of the base member 54 in the width direction orthogonal to the conveyance direction is larger than the maximum width W of the sheet S in the width direction (Wd>W) in order to prevent the water vapor contained in the sheet S from advecting to the entire upper surface of the intermediate transfer belt unit 8 (refer to FIG. 4).

The second fan 56 operates under the control of the control circuit portion A to generate an air flow from the intake port 52 toward the exhaust port 53.

The duct 57 is formed by the base member 54 and the plate member 51, and connects the intake port 52 and the exhaust port 53. The duct 57 constitutes a ventilation passage that guides air sucked from the intake port 52 to the exhaust port 53. The duct 57 does not include a ventilation resistor such as a filter on the ventilation passage.

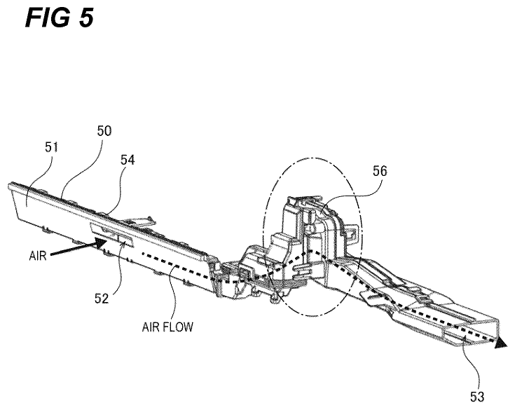

In the duct unit 50 having the above configuration, the air taken in from the intake port 52 is exhausted from the exhaust port 53 through a path indicated by an arrow in FIG. 5. The second fan 56 is disposed on an air path indicated by an arrow in FIG. 5. Since the duct unit 50 needs to generate an air volume equal to or larger than a certain amount in order to prevent dew condensation on the intermediate transfer belt 9, a ventilation resistor such as a filter is not provided on a path indicated by an arrow in FIG. 5.

### Operation of Image Forming Apparatus

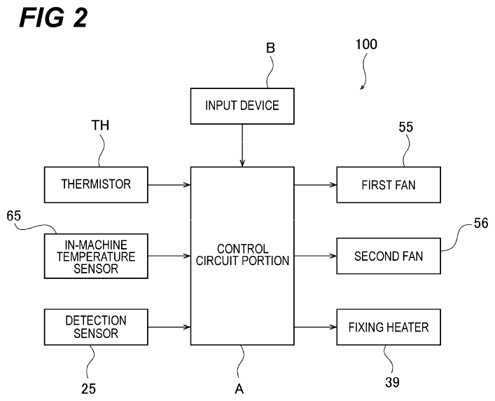

The operation of the image forming apparatus 100 according to the embodiment of the present invention will be described in detail with reference to FIGS. 1 and 2.

The image forming apparatus 100 starts operation at a timing when image information is input from the input device B such as a personal computer to the control circuit portion A.

First, the control circuit portion A takes out one sheet S from the sheet cassette 11 and conveys the sheet S to the image forming portion 1 by a sheet feeding mechanism including a feeding roller 13.

On the sheet S conveyed to the image forming portion 1, an unfixed toner image is formed by the toner image forming operation in the image forming portion 1.

The sheet S on which the unfixed toner image is formed by the image forming portion 1 passes through the discharge roller pair 26 after the toner image is fixed in the fixing device 19.

The detection sensor 25 on the downstream side of the discharge roller pair 26 in the conveyance direction detects that the sheet S that passed through the discharge roller pair 26 passes the tip end portion in the conveyance direction.

The sheet S of which the tip end portion in the conveyance direction is detected by the detection sensor 25 is discharged to the discharge tray 22 via the discharge roller pair 21, and the passage of the rear end in the conveyance direction is detected by the detection sensor 25.

The control circuit portion A counts the conveyance distance of the sheet S based on the detection timing of the tip end portion of the sheet S in the conveyance direction indicated by the electric signal input from the detection sensor 25, the conveyance speed of the sheet S, and the distance from the fixing nip portion N to the detection sensor 25. The information on the conveyance speed of the sheet S and the information on the conveyance distance from the fixing nip portion N to the detection sensor 25 are stored in advance in a storage unit (not illustrated) and read out from the storage unit by the control circuit portion A. Then, the control circuit portion A controls the operation of the second fan 56 based on the counted count value of the conveyance distance of the sheet S.

Here, in the above-described image forming operation, generation of UFP and water vapor is a problem. The UFP is obtained by condensing volatiles of wax as a release agent contained in the toner into particles in the air. In order to make the concentration of particles contained in the exhaust gas from the image forming apparatus 100 lower than the reference value defined in the environmental standard such as the Blue Angel standard, it is necessary to suppress the generation of UFP.

Further, when the sheet S is heated at the fixing nip portion N, moisture contained in the sheet S is diffused as water vapor. Such water vapor causes dew condensation on circumferential components and adversely affects the quality of an image formed on the sheet S. In addition, most of the water vapor is generated on the downstream side in the conveyance direction of the fixing device 19 (upward side in FIG. 1), and causes dew condensation on components on the conveyance path such as the guide member 20. The moisture adhering to the component in this manner shifts to the sheet S, and causes wrinkles or the like in the sheet S.

Further, a part of the water vapor generated on the downstream side in the conveyance direction of the fixing nip portion N is shifted to the upstream side in the conveyance direction of the fixing nip portion N (downward side in FIG. 1) by the air flow generated along with the rotation of the fixing belt 27 and the pressure roller 28. A small amount of such water vapor that shifted to the upstream side is condensed slightly on the intermediate transfer belt 9. The moisture condensed on the intermediate transfer belt 9 reacts with a filler or the like contained in the sheet S, and a reaction product of the moisture condensed on the intermediate transfer belt 9 and the filler or the like may be deposited on the intermediate transfer belt 9. Such deposits deteriorate the image quality of the unfixed toner image formed at the secondary transfer nip portion 17.

Therefore, the control circuit portion A operates the first fan 55 to collect and discharge the water vapor floating on the downstream side in the conveyance direction of the fixing device 19. The control circuit portion A operates the second fan 56 after the secondary transfer roller 16 starts the secondary transfer operation at the secondary transfer nip portion 17. When the second fan 56 operates, air containing water vapor between the fixing device 19 and the intermediate transfer belt 9 is taken into the duct 57 via the intake port 52 and discharged from the exhaust port 53 to the outside of the image forming apparatus 100. Accordingly, dew condensation on components on the conveyance path such as the guide member 20 and the intermediate transfer belt 9 can be suppressed.

Air suction and exhaust by the duct unit 50 also serve to exhaust heat generated from the fixing device 19. As a result, the temperature of the intermediate transfer belt unit 8 can be maintained at an appropriate temperature.

However, the discharge of air by the duct unit 50 can promote the generation of UFP while suppressing dew condensation on the components on the conveyance path such as the guide member 20 and the intermediate transfer belt 9. Therefore, in the related art, it is difficult to achieve both dew condensation prevention and UFP reduction only by an exhaust duct not including a filter.

On the other hand, the image forming apparatus 100 according to the present embodiment can achieve both dew condensation prevention and UFP reduction only by the duct unit 50. Next, the UFP generation mechanism will be described, and the operation and processing of the image forming apparatus 100 according to the present embodiment for achieving both dew condensation prevention and UFP reduction only by the duct unit 50 will be described.

### UFP Generation Mechanism

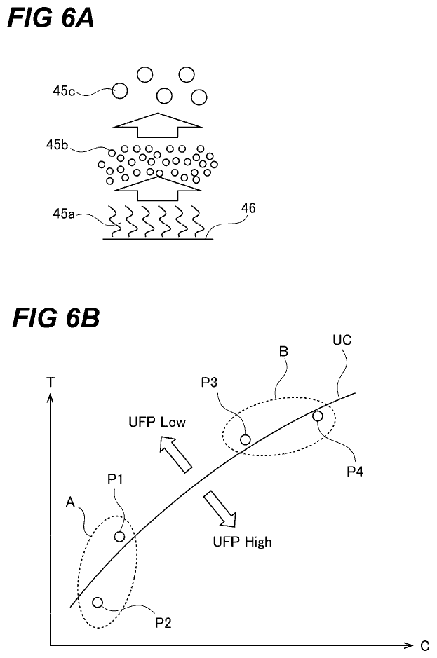

A UFP generation mechanism in the image forming apparatus 100 according to the embodiment of the present invention will be described in detail with reference to FIGS. 6A and 6B.

In FIGS. 6A and 6B, FIG. 6A schematically illustrates a UFP generation mechanism, and FIG. 6B illustrates a relationship of the UFP generation, the concentration C of wax vapor, and the space temperature T.

The fixing device 19 brings the high-temperature fixing belt 27 into contact with the sheet S at the fixing nip portion N to fix the toner image on the sheet S. At this time, an offset phenomenon or the like in which a part of the toner on the sheet S adheres to the fixing belt 27 may occur. Such toner adhering to the fixing belt 27 causes an image defect.

Therefore, in order to suppress adhesion of the toner to the fixing belt 27, a toner containing wax made of, for example, paraffin, which is a release agent, is used. When the toner containing such a wax is heated, the melted wax seeps out from the front surface, and the seeping wax is transferred to the fixing belt 27 at the time of fixing processing. Since the front surface of the fixing belt 27 is covered with the wax, adhesion of the toner to the fixing belt 27 can be suppressed by the releasing action of the wax.

The above-described wax includes, in addition to a pure wax, a compound containing a molecular structure of a wax such as a compound in which a resin molecule of a toner reacts with a wax molecular structure such as a hydrocarbon chain. The release agent is not limited to wax, and a substance having a release action such as silicone oil may be used.

On the other hand, a part of the wax adhering to the fixing belt 27 is vaporized (gasified) when the surface temperature of the fixing belt 27 becomes a predetermined temperature or more. The vaporized wax component solidifies when cooled in the air, and becomes a particulate UFP having a particle diameter of about several nm to several hundred nm.

Such UFP is generated by the process illustrated in FIG. 6A. Specifically, when the front surface 46 of an object such as the fixing belt 27 to which the wax adheres is heated to such an extent that the wax volatilizes, vapor 45a of wax is generated from the surface 46. The vapor 45a of wax generated from the front surface 46 cools and begins to condense as the vapor 45a leaves the front surface 46. As a result, a nucleus 45b, which is a mass of molecules in which molecules constituting the vapor 45a are bonded to each other, is generated. Such a phenomenon that the nucleus 45b is generated is referred to as nucleation. Then, the nuclei 45b collide with each other and coalesce into a large mass to form a UFP 45c. The nucleation phenomenon is a phenomenon that also occurs in generation of mist in the atmosphere.

Such a nucleation phenomenon is a phenomenon that governs the number of UFPs generated. Therefore, in order to reduce the UFP, it is important to control the nucleation phenomenon.

Next, the generation conditions of the nucleus 45b will be described in detail with reference to FIG. 6B. In FIG. 6B, the horizontal axis represents the concentration C of the wax vapor, and the vertical axis represents the space temperature T. A curve UC illustrated in FIG. 6B is a combination of the space temperature T at which the nucleation rate is constant and the concentration C of wax vapor based on the classical nucleation theory.

The generation rate of the nucleus 45b can be obtained by a nucleation rate equation derived by classical nucleation theory. The nucleation rate equation uses the physical properties of the wax vapor molecules, the space temperature T, and the concentration C of the wax vapor as parameters. The generation rate of the nucleus 45b is a function of the concentration C of the wax vapor and the space temperature T when the physical properties of the wax vapor molecules are fixed. Since the generation of the nucleus 45b is a condensation phenomenon, similarly to the generation of the mist, the generation of the nucleus 45b is less likely to occur as the space temperature T is higher and the concentration C of the wax vapor is lower.

Specifically, in FIG. 6B, an upper left direction from the curve UC (the arrow UFP Low direction in FIG. 6B) is a direction in which the UFP is reduced because the space temperature T is high and the concentration C of the wax vapor is low. On the other hand, in FIG. 6B, the lower right direction from the curve UC (the arrow UFP High direction in FIG. 6B) is a direction in which the UFP is increased because the space temperature T is low and the concentration C of the wax vapor is high.

In addition, the generation of the nucleus 45b occurs around the fixing belt 27 where wax vapor is generated. The wax vapor volatilized from the fixing belt 27 is carried to the upstream side of the fixing nip portion N in the conveyance direction by the air flow generated along with the fixing belt 27 rotating in the counterclockwise direction in FIG. 3. Therefore, in the generation of the nucleus 45b, the generation of the nucleus 45b generated in the vicinity of the sheet inlet portion 35 on the upstream side of the fixing nip portion N in the conveyance direction is dominant.

The air flow generated at the intake port 52 of the duct unit 50 changes the space temperature T and the concentration C of the wax vapor, and thus affects the generation of the nucleus 45b in the vicinity of the sheet inlet portion 35 and the generation of UFP. As described above, the duct unit 50 is involved not only in the dew condensation prevention on the intermediate transfer belt 9 but also in the generation of UFP.

### Effect of Operation of Second Fan

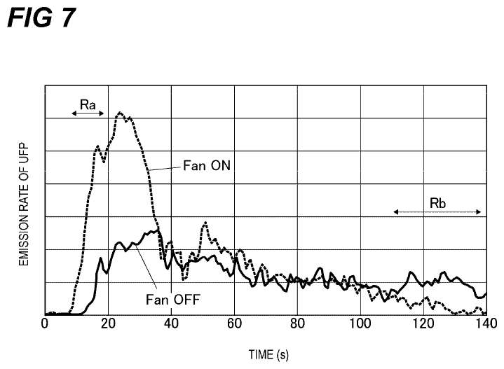

An effect of the operation of the second fan 56 of the image forming apparatus 100 according to the embodiment of the present invention will be described in detail with reference to FIGS. 6A, 6B, and 7.

FIG. 7 illustrates the lapse of time of the emission rate of the UFP (UFP Emission Rate) generated in the image forming apparatus 100 when the second fan 56 is in operation (Fan On) and when the second fan 56 is not in operation (Fan Off). The emission rate of the UFP on the vertical axis in FIG. 7 increases toward the upper side of the vertical axis. In addition, the generation amount of the UFP increases as the emission rate of the UFP increases. A time region Ra in FIG. 7 is a time region corresponding to a region A in FIG. 6B, and a time region Rb in FIG. 7 is a time region corresponding to a region B in FIG. 6B.

The operation of the second fan 56 prevents dew condensation on the intermediate transfer belt 9 and may amplify or reduce the generation of UFP depending on the state of the image forming apparatus 100.

In a region A surrounded by a broken line in FIG. 6B, the relationship between the space temperature T and the concentration C of wax vapor immediately after the image forming apparatus 100 starts operation (hereinafter described as “cold operation”) in a state of conforming to room temperature and being cooled is illustrated. A plot P1 in the region A indicates the relationship between the space temperature T and the concentration C of the wax vapor when the second fan 56 is in the operating state (Fan On). A plot P2 in the region A indicates the relationship between the space temperature T and the concentration C of the wax vapor when the second fan 56 is in the stopped state (Fan Off).

In addition, in the region B surrounded by a broken line in FIG. 6B, a relationship between the space temperature T in the vicinity of the sheet inlet portion 35 and the concentration C of wax vapor when the image forming apparatus 100 is continuously operated (hereinafter described as “warm operation”) for about several minutes. A plot P3 in the region B indicates the relationship between the space temperature T and the concentration C of the wax vapor when the second fan 56 is in the operating state (Fan On). A plot P4 in the region B indicates the relationship between the space temperature T and the concentration C of the wax vapor when the second fan 56 is in the stopped state (Fan Off).

The concentration C of the wax vapor when the second fan 56 is not in operation in the region A is low because it is immediately after the start of sheet passing. In addition, the space temperature T in a case where the second fan 56 is not in operation in the region A is slightly high because heat generated from the fixing belt 27 by the start of sheet passage is accumulated in addition to heat generated by sheet passing.

Accordingly, the plot Pl where the second fan 56 is stopped in the region A is on the lower side of the UFP. On the other hand, in the plot P2 in which the second fan 56 is operated in the region A, the space temperature T rapidly decreases due to the exhaust heat, and thus, the UFP is on the high side. That is, the generation amount of UFP when the second fan 56 is in operation in the region A exceeds the generation amount of UFP when the second fan 56 is not in operation in the region A, as illustrated in the time region Ra of FIG. 7.

The concentration C of the wax vapor when the second fan 56 is not operated in the region B is high because the image forming apparatus 100 is filled with a large amount of wax vapor generated by continuous operation. In addition, the temperature T when the second fan 56 is not operated in the region B is high due to continuous operation of the image forming apparatus 100.

Accordingly, the plot P4 where the second fan 56 is stopped in the region B is on the high side of the UFP. On the other hand, in the plot P3 in which the second fan 56 is operated in the region B, since the filled wax vapor is discharged and the concentration C rapidly decreases and the heat generated from the fixing belt 27 spreads around the fixing device 19, the temperature T hardly decreases, and thus the UFP is on the low side. That is, the generation amount of UFP when the second fan 56 is in operation in the region B is lower than the generation amount of UFP when the second fan 56 is not in operation, as illustrated in the time region Rb of FIG. 7.

As described above, the UFP is high immediately after the start of operation of the image forming apparatus 100 having a low temperature in the image forming apparatus 100, and decreases as the temperature in the image forming apparatus 100 increases with the lapse of time from the start of operation due to suppression of nucleation. Accordingly, in order to reduce the generation of UFP, it is understood that the second fan 56 should be stopped immediately after the start of the operation of the image forming apparatus 100, and the second fan 56 should be operated during the continuous operation of the image forming apparatus 100. On the other hand, in order to prevent dew condensation, it is advantageous to always operate the second fan 56. Therefore, in order to achieve both UFP reduction and dew condensation prevention, the operation of the second fan 56 needs to be devised.

### Operation of Second Fan

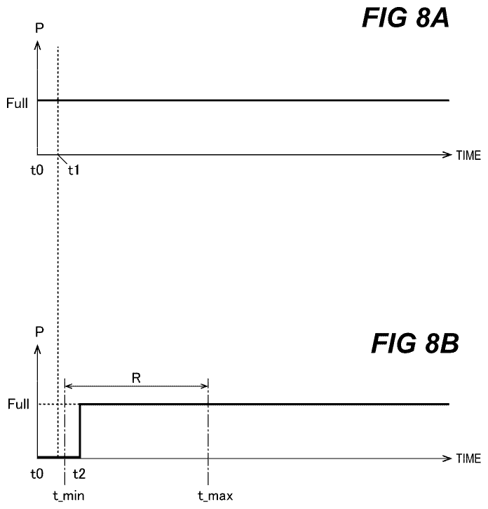

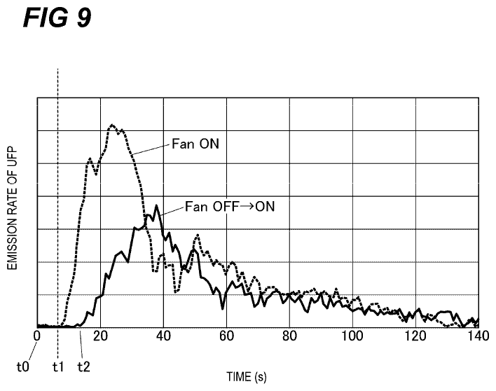

The operation of the second fan 56 of the image forming apparatus 100 according to the embodiment of the present invention will be described in detail with reference to FIGS. 8A, 8B, and 9.

In FIGS. 8A and 8B, FIG. 8A illustrates a case where the second fan 56 is constantly operated in comparison with the present embodiment, and FIG. 8B illustrates time transition of the operating state of the second fan 56 of the image forming apparatus 100 according to the present embodiment. In FIGS. 8A and 8B, the horizontal axis represents time, and the vertical axis represents the power P of the second fan 56.

Fan ON indicated by a broken line in FIG. 9 indicates transition of the emission rate of the UFP when the second fan 56 performs the operation illustrated in FIG. 8A. Fan OFF→ON indicated by a solid line in FIG. 9 indicates transition of the emission rate of the UFP when the second fan 56 performs the operation illustrated in FIG. 8B. The emission rate of the UFP on the vertical axis in FIG. 9 increases toward the upper side of the vertical axis.

In FIGS. 8A, 8B, and 9, time t0 is the time when the temperature control is started, and time t1 is the time when the sheet passing is started.

When the secondary transfer operation is started in the secondary transfer nip portion 17 by the secondary transfer roller 16, the control circuit portion A starts the operation of the second fan 56 when the conveyance distance of the sheet S passing through the fixing nip portion N reaches a predetermined value. Specifically, when starting the secondary transfer operation, as illustrated in FIG. 8B, the control circuit portion A sets the second fan 56 to the non-operating (OFF) state from time t0 to time t2, and operates the second fan 56 with full power after time t2. As illustrated in FIG. 9, the emission rate of the UFP in this case is suppressed to be lower than the emission rate of the UFP in a case where the second fan 56 is constantly operated.

At this time, when the operation start timing of the second fan 56 is too early, the UFP increases, and when the operation start timing of the second fan 56 is too late, dew condensation occurs on the intermediate transfer belt 9.

Here, in a case where the amount of toner on the sheet S is constant, the concentration C of the wax vapor that governs the generation of UFP increases as the sheet S passes through the fixing nip portion N more, and increases as the conveyance distance of the sheet S increases. In addition, the generation of water vapor, which governs due condensation, increases as more sheets S pass through the fixing nip portion N, and increases as the conveyance distance of the sheet S becomes longer. Therefore, the control circuit portion A starts the operation of the second fan 56 at time t2 within the time range R from time t_min to time t_max at which both the reduction of the generation of UFP and the dew condensation prevention can be achieved. That is, time t_min is the shortest time at which the effect of reducing the generation of UFP can be obtained by operating the fan from this time. The time t_max is the maximum time at which dew condensation occurs unless the fan is operated until this time. The time t_min and time t_max are set according to the conveyance distance of the sheet S passing through the fixing nip portion N.

Specifically, by operating the second fan 56 from time t_min at which the conveyance distance of the sheet S at which the tip end portion of the sheet S in the conveyance direction passes through the fixing nip portion N reaches 660 mm, a desired UFP reduction effect can be obtained. In addition, by starting the operation of the second fan 56 by time t_max when the conveyance distance of the sheet S at which the tip end portion of the sheet S in the conveyance direction passes through the fixing nip portion N reaches 12,600 mm, a desired dew condensation prevention effect could be obtained. Accordingly, in order to achieve both UFP reduction and dew condensation prevention, the control circuit portion A operates the second fan 56 when the conveyance distance of the sheet S is 660 mm or more and 12,600 mm or less as the first predetermined value.

When the conveyance speed of the sheet S is 264 mm/s, the time required to convey the sheet S by a conveyance distance of 660 mm is 2.5 seconds. In this case, from FIG. 7, it is found that the second fan 56 should be operated before 105 seconds elapse in order to obtain a desired UFP reduction effect. Furthermore, in this case, the time required to convey a conveyance distance of 12,600 mm is 67 seconds. Therefore, in order to achieve both UFP reduction and dew condensation prevention, the control circuit portion A operates the second fan 56 2.5 seconds after passing through the fixing nip portion N at the tip end portion in the conveyance direction of the sheet S and 67 seconds after passing through the fixing nip portion N at the tip end portion in the conveyance direction of the sheet S.

Here, the timing to start the operation of the second fan 56 is, for example, 17 seconds required to convey the sheet S by 2,100 mm from the time when the sheet S passes through the fixing nip portion N at the tip end portion in the conveyance direction.

For example, the sheet S of A4 size (the length in the conveyance direction is 210 mm) is conveyed at intervals of about 0.2 seconds during continuous sheet passing. Therefore, t_min of the A4 size sheet S is 10.1 seconds obtained by adding the time of 0.2 seconds for each of the sheet interval between the first sheet and the second sheet, the sheet interval between the second sheet and the third sheet, and the sheet interval between the third sheet and the fourth sheet, the above-described 2.5 seconds, and the time of 7 seconds from time t=0 to time t1.

Since the conveyance distance of the sheet S directly affects the generation of UFP and the generation of the water vapor, the timing of starting the operation of the second fan 56 is basically set based on the conveyance distance regardless of whether or not a part of the sheet S remains in the fixing nip portion N. On the other hand, it is preferable to start the operation of the second fan 56 at the timing when the tip end portion of the sheet S in the conveyance direction is detected by the detection sensor 25 from the viewpoint of ease of creation of the control program.

However, in the case of performing such control, the timing of starting the operation of the second fan 56 is slightly delayed as compared with the case of starting the operation of the second fan 56 at the timing when the tip end portion of the sheet S in the conveyance direction passes through the fixing nip portion N. On the other hand, as described above, the control circuit portion A calculates the conveyance distance of the sheet S by adding the distance from the fixing nip portion N to the detection sensor 25 and the conveyance distance of the sheet S after the tip end portion of the sheet S in the conveyance direction is detected by the detection sensor 25. Then, the control circuit portion A operates the second fan 56 when the calculated conveyance distance of the sheet S is 660 mm or more and 12,600 mm or less.

Note that a control program for controlling the operation of the second fan 56 according to only the conveyance distance of the sheet S after the tip end portion of the sheet S in the conveyance direction is detected by the detection sensor 25 may be created. Even in this case, by preventing the conveyance distance of the sheet S in which the tip end portion of the sheet S in the conveyance direction passes through the fixing nip portion N from exceeding 12,600 mm, it is possible to achieve both UFP reduction and dew condensation prevention. For example, the operation of the second fan 56 can be started after 17 seconds required to convey the sheet S by 2,100 mm elapsed after the tip end portion of the sheet S in the conveyance direction is detected by the detection sensor 25.

In addition, UFP and dew condensation are more likely to occur as the space temperature becomes lower. Therefore, the control circuit portion A preferably performs the above control of the second fan 56 when the space temperature indicated by the electric signal input from the in-machine temperature sensor 65 before the start of the secondary transfer operation by the secondary transfer roller 16 is 10° C. or more and 30° C. or less. This makes it possible to reliably suppress the generation of UFP and dew condensation. Note that the control circuit portion A may perform the above control of the second fan 56 when the temperature indicated by the electric signal input from the thermistor TH before the start of the secondary transfer operation by the secondary transfer roller 16 is 10° C. or higher and 30° C. or lower.

In addition, the intake port 52 is provided on the fixing belt 27 side with respect to the conveyance path of the sheet S between the secondary transfer roller 16 and the fixing device 19. As a result, the intake port 52 can be provided in the vicinity of the intermediate transfer belt 9 to be prevented from dew condensation and the fixing belt 27 that generates wax vapor.

In addition, by providing the intake port 52 in the vicinity of the substantially central portion in the longitudinal direction of the plate member 51, the area of the intake port 52 can be reduced as compared with the case where the intake port 52 is provided over the entire plate member 51 in the longitudinal direction. As a result, since the intake speed in the intake port 52 can be increased, the concentration C of the wax vapor around the fixing belt 27 and the space temperature T can be quickly controlled.

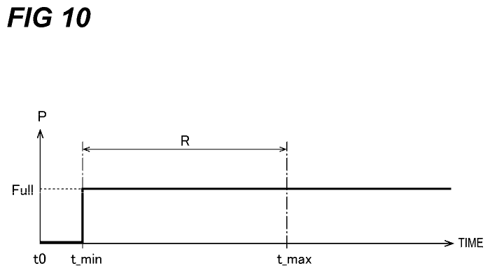

The control circuit portion A is not limited to the case of operating the second fan 56 as illustrated in FIG. 8B, and may operate the second fan 56 as illustrated in FIG. 10. In the case of FIG. 10, the control circuit portion A starts the operation of the second fan 56 at time t_min when dew condensation is likely to occur, for example, when the sheet S is thick paper containing a large amount of moisture, or when the installation environment temperature of the image forming apparatus 100 is low. Accordingly, dew condensation can be effectively prevented even under conditions where dew condensation is likely to occur.

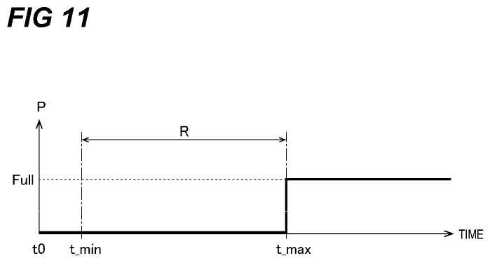

The control circuit portion A may operate the second fan 56 as illustrated in FIG. 11. In the case of FIG. 11, the control circuit portion A starts the operation of the second fan 56 at time t_max when dew condensation is less likely to occur, for example, when the sheet S is thin paper not containing a large amount of moisture, or when the installation environment temperature of the image forming apparatus 100 is high. As a result, the dew condensation prevention effect can be secured, and the noise due to the operation of the second fan 56 can be reduced by delaying the operation of the second fan 56.

Furthermore, the control circuit portion A may vary the timing of starting the operation of the second fan 56 within the time range R according to the type of the sheet S or the space temperature. Specifically, when the sheet S contains a large amount of moisture such as thick paper, or when the space temperature is low, the control circuit portion A advances the operation timing of the second fan 56 to prevent dew condensation. On the other hand, when the sheet S does not contain much moisture such as thin paper or when the space temperature is high, the control circuit portion A delays the operation timing of the second fan 56 to reduce the UFP and reduce the noise due to the operation of the second fan 56.

In this case, the image forming apparatus 100 includes a storage unit (not illustrated) that stores a table in which the type of the sheet S is associated with the operation start time of the second fan 56. The control circuit portion A operates the second fan 56 when the operation start time associated with the type of the sheet S indicated by the electric signal input from the input device B in the above-described table is reached after the tip end portion of the sheet S in the conveyance direction passes through the fixing nip portion N. As a result, the control circuit portion A can vary the operation timing of the second fan 56.

In addition, the image forming apparatus 100 includes a storage unit (not illustrated) that stores a table in which the space temperature and the operation start time of the second fan 56 are associated with each other. The control circuit portion A operates the second fan 56 when the operation start time associated with the space temperature indicated by the electric signal input from the in-machine temperature sensor 65 in the above-described table is reached after the tip end portion of the sheet S in the conveyance direction passes through the fixing nip portion N. As a result, the control circuit portion A can vary the operation timing of the second fan 56.

In addition, the image forming apparatus 100 includes a storage unit (not illustrated) that stores a table in which the space temperature and the operation start time of the second fan 56 are associated with each other. The control circuit portion A operates the second fan 56 when the operation start time associated with the space temperature indicated by the electric signal input from the in-machine temperature sensor 65 in the above-described table is reached after the tip end portion of the sheet S in the conveyance direction passes through the fixing nip portion N. As a result, the control circuit portion A can vary the operation timing of the second fan 56.

In the present embodiment, when the transfer operation is started, the operation of the second fan 56 is started when the conveyance distance of the sheet S passing through the fixing nip portion N reaches a predetermined value. As a result, reduction of ultrafine particles generated by heating of the release agent contained in the toner, exhaust heat, and discharge of water vapor can be realized only by the duct 57, and thus downsizing can be achieved.

In the present embodiment, the distance from the fixing nip portion N to the detection sensor 25 and the conveyance distance of the sheet S detected by the detection sensor 25 (=the length of the sheet) are added to calculate the conveyance distance of the sheet S (the length of the sheet S that passed through the fixing nip portion N). That is, the conveyance distance of the sheet S that passed through the fixing nip portion N=the distance from the fixing nip portion N to the detection sensor 25+(the length of the sheet S that passed through the detection sensor 25 in the conveyance direction)×(the number of the conveyed sheets S).

The reason why the distance from the fixing nip portion N to the detection sensor 25 is added in the above description is that the UFP and moisture are evaporated from the sheet S after fixing even during the conveyance until the first sheet S that passed through the fixing nip portion N reaches the detection sensor 25. The distance from the fixing nip portion N to the detection sensor 25 is, for example, about 30 mm. Then, the second fan 56 is operated when the calculated conveyance distance of the sheet S is 660 mm or more and 12,600 mm or less.

However, the present invention is not limited thereto, and the operation of the second fan 56 may be started when the conveyance distance of the sheet S reaches, for example, 2,100 mm which is less than 12,600 mm. In this case, the second predetermined value is set such that a value obtained by adding the distance from the fixing nip portion N to the detection sensor 25 to the second predetermined value does not exceed 12,600 mm.

### Embodiment 2

### Configuration of Image Forming Apparatus>

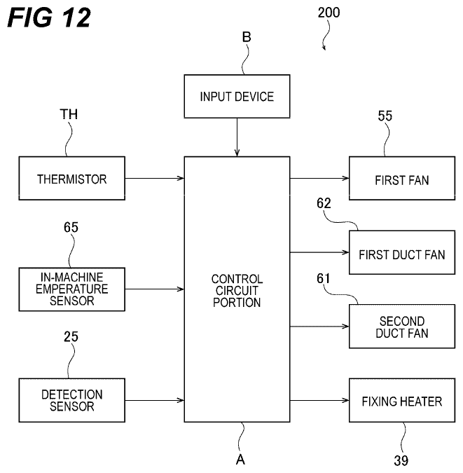

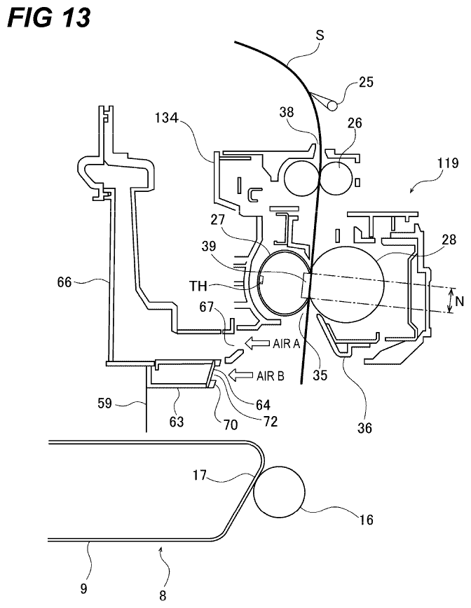

A configuration of an image forming apparatus 200 according to Embodiment 1 of the present invention will be described in detail with reference to FIGS. 12 and 13.

Note that, in FIGS. 12 and 13, parts having the same configurations as those in FIGS. 1 to 3 will be given the same reference numerals, and description thereof will be omitted.

Here, the image forming apparatus 200 is exemplified by a tandem- intermediate transfer-type four-color full-color laser printer using an electrophotographic process. The image forming apparatus 200 forms an image on a sheet S as a recording material based on image information input from the input device B such as a personal computer to the control circuit portion A. Note that the image forming apparatus 200 is a color electrophotographic apparatus such as a color copying machine including a plurality of photosensitive drums, but is not limited thereto, and may be a monochrome electrophotographic apparatus such as a monochrome copying machine or a printer including one photosensitive drum.

Specifically, the image forming apparatus 200 includes the image forming portion 1, the belt suspension roller 10, the sheet feeding roller 13, the registration roller 14a, the registration roller 14b, the guide member 15, and the secondary transfer roller 16. The image forming apparatus 200 includes the guide member 18, the guide member 20, the discharge roller pair 21, the discharge tray 22, the toner bottles 23Y, 23M, 23C, and 23K, and the detection sensor 25. The image forming apparatus 200 further includes the first fan 55, a sheet member 59, a second duct unit 63, the in-machine temperature sensor 65, a first duct unit 66, the fixing device 119, and the control circuit portion A.

The sheet member 59 is provided in the second duct unit 63 to assist prevention of advection of water vapor contained in the sheet S to the intermediate transfer belt unit 8. The sheet member 59 extends from the second duct unit 63 toward the intermediate transfer belt 9 on the downstream side of the secondary transfer nip portion 17 in the conveyance direction of the toner image by the intermediate transfer belt 9.

The fixing device 119 as a fixing unit is a belt-heating type on-demand fixing device, and has a vertical path configuration that conveys the sheet S from the lower side to the upper side in the direction of gravity. Note that the fixing device 119 is not limited to the vertical path configuration, and may have a horizontal path configuration for conveying the sheet S in the horizontal direction.

The fixing device 119 performs heat-fixing processing of applying heat and pressure at the fixing nip portion N to the toner image, which is secondarily transferred to the sheet S conveyed from the secondary transfer nip portion 17 by the secondary transfer roller 16, to fix the toner image on the sheet S. The fixing device 119 conveys the sheet S, on which the toner image is fixed, to the discharge roller pair 21. Note that details of the configuration of the fixing device 119 will be described later.

The guide member 20 is provided between the fixing device 119 and the discharge roller pair 21. The guide member 20 guides conveyance of the sheet S conveyed between the fixing device 119 and the discharge roller pair 21 on the conveyance path 12.

The first fan 55 is disposed on the downstream side in the conveyance direction of the fixing device 119. The first fan 55 operates under the control of the control circuit portion A to collect and discharge water vapor floating on the downstream side in the conveyance direction of the fixing device 119.

The second duct unit 63 sucks air between the fixing device 119 and the intermediate transfer belt 9 and air between the fixing device 119 and the secondary transfer roller 16 and discharges the air to the outside of the image forming apparatus 200. Details of the configuration of the second duct unit 63 will be described later.

The first duct unit 66 sucks air between the fixing device 119 and the intermediate transfer belt 9 and air between the fixing device 119 and the secondary transfer roller 16, and discharges the air to the outside of the image forming apparatus 200. Details of the configuration of the first duct unit 66 will be described later.

The control circuit portion A controls the entire operation of the image forming apparatus 200 based on the image information input from the input device B. The control circuit portion A controls the operation of a first duct fan 62 (described later) of the first duct unit 66 based on the detection result of the sheet S indicated by the electric signal input from the detection sensor 25 and the space temperature indicated by the electric signal input from the in-machine temperature sensor 65. The control circuit portion A controls the operation of a second duct fan 61 (described later) of the second duct unit 63 based on the detection result of the sheet S indicated by the electric signal input from the detection sensor 25 and the space temperature indicated by the electric signal input from the in-machine temperature sensor 65.

In the image forming apparatus 200 having the above-described configuration, the sheet feeding roller 13, the registration roller 14a and the registration roller 14b, the secondary transfer roller 16, the fixing device 119, and the discharge roller pair 21 are provided in this order from the lower side to the upper side of the conveyance path 12.

### Configuration of Fixing Device

A configuration of the fixing device 119 of the image forming apparatus 200 according to Embodiment 2 of the present invention will be described in detail with reference to FIGS. 12 and 13.

The fixing device 119 includes the discharge roller pair 26, the fixing belt 27, the pressure roller 28, the fixing heater 39, the heater holder 40, the rigid stay 41, a housing 134, and the thermistor TH.

The discharge roller pair 26 is provided on the downstream side in the conveyance direction of the fixing belt 27 and the pressure roller 28, and conveys the sheet S conveyed by the fixing belt 27 and the pressure roller 28 to the discharge roller pair 21.

The housing 134 houses the discharge roller pair 26, the fixing belt 27 and the pressure roller 28. The housing 134 includes the sheet inlet portion 35, the first guide member 36, and the sheet outlet portion 38.

The sheet inlet portion 35 is an inlet of the fixing device 119 when the sheet S is conveyed from the secondary transfer roller 16 to the fixing device 119.

The sheet outlet portion 38 is an outlet of the fixing device 119 when the sheet is conveyed to the discharge roller pair 21 by the discharge roller pair 26.

In the fixing device 119 having the above configuration, the pressure roller 28 is rotationally driven, and the temperature detected by the thermistor TH is adjusted to a predetermined target temperature by the control circuit portion A. In this state, the sheet S to which the unfixed toner image is transferred by the secondary transfer nip portion 17 is conveyed to the fixing device 119 via the sheet inlet portion 35. The toner image is fixed on the sheet S conveyed to the fixing device 119. Then, the sheet S on which the toner image is fixed is discharged from the sheet outlet portion 38.

### Configurations of First Duct Unit and Second Duct Unit

Configurations of the first duct unit 66 and the second duct unit 63 of the image forming apparatus 200 according to Embodiment 2 of the present invention will be described in detail with reference to FIGS. 13 to 15B.

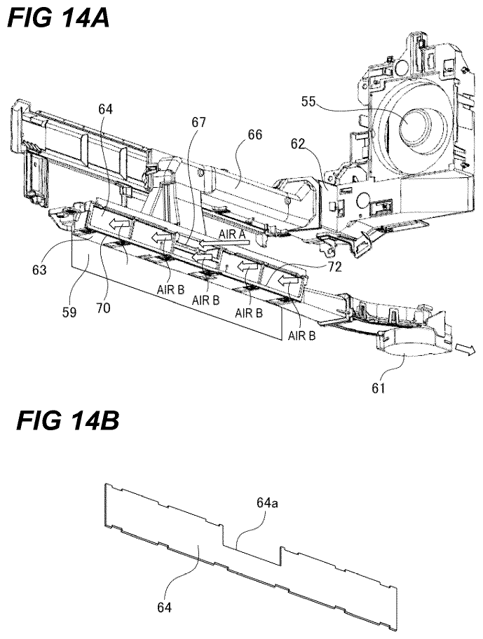

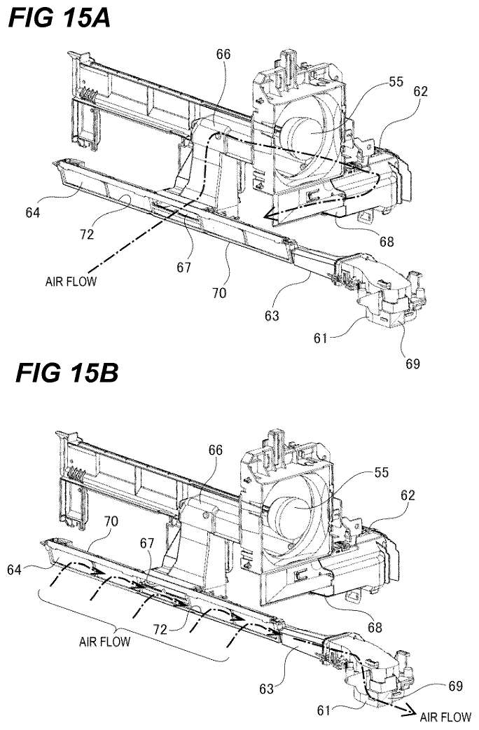

In FIGS. 14A and 14B, FIG. 14A is a perspective view of the first duct unit 66 and the second duct unit 63, and FIG. 14B is a perspective view of a filter 64. In addition, in FIGS. 15A and 15B, FIG. 15A is a view illustrating an air flow of the first duct unit 66, and FIG. 15B is a view illustrating an air flow of the second duct unit 63.

The surface temperature of the fixing belt 27 of the fixing device 119 of the image forming apparatus 200 is set to be higher than the surface temperature of the fixing belt 27 of the fixing device 19 of the image forming apparatus 100 in order to enhance the fixing performance of the toner image. As a result, the amount of wax vapor generated from the fixing belt 27 of the image forming apparatus 200 and the amount of UFP generated from the wax vapor are larger than the amount of wax vapor and the amount of UFP generated from the fixing belt 27 of the image forming apparatus 100. On the other hand, in order to improve the UFP reduction capability, the image forming apparatus 200 of the present embodiment includes the second duct unit 63 including the filter 64 for removing UFP in addition to the first duct unit 66 mainly intended to discharge water vapor.

First, the configuration of the first duct unit 66 will be described in detail.

The first duct unit 66 includes a first duct 60, the first duct fan 62, an intake port 67, and an exhaust port 68.

The intake port 67 as a first intake port is provided in the first duct 60. The intake port 67 is provided on the fixing belt 27 side with respect to the conveyance path 12 of the sheet S between the secondary transfer roller 16 and the fixing device 119. The intake port 67 is provided at the central portion in the rotation axial direction of the fixing belt 27 (direction orthogonal to the paper surface in FIG. 13). The intake port 67 is provided adjacent to the intake port 72. The intake port 67 takes air between the fixing device 119 and the intermediate transfer belt 9 sucked by the first duct fan 62 and air (air A) between the fixing device 119 and the secondary transfer roller 16 into the first duct 60.

The exhaust port 68 as a first exhaust port exhausts air sucked and taken into the first duct 60 via the intake port 67 by the first duct fan 62 to the outside of the image forming apparatus 200.

The first duct fan 62 operates under the control of the control circuit portion A to generate an air flow from the intake port 67 toward the exhaust port 68. The first duct fan 62 is provided to discharge water vapor.

The first duct 60 connects the intake port 67 and the exhaust port 68. The first duct 60 constitutes a first ventilation passage that guides air sucked from the intake port 67 to the exhaust port 68.

In the first duct unit 66 having the above configuration, the air taken in from the intake port 67 passes through the first ventilation passage indicated by an arrow of the one-dot chain line in FIG. 15A and is exhausted from the exhaust port 68. The first duct fan 62 is disposed in the first ventilation passage. Since the first duct unit 66 needs to generate an air volume equal to or larger than a certain amount in order to prevent dew condensation on the intermediate transfer belt 9, a ventilation resistor such as a filter is not provided on the first ventilation passage.

Next, the configuration of the second duct unit 63 will be described in detail.

The second duct unit 63 includes the second duct fan 61, the filter 64, an exhaust port 69, a frame member 70, a second duct 71, and an intake port 72.

The second duct fan 61 operates under the control of the control circuit portion A to generate an air flow from the intake port 72 toward the exhaust port 69. The second duct fan 61 is provided to remove the UFP.

The filter 64 has an elongated shape in accordance with the shape of the frame member 70. The filter 64 includes a cutout portion 64a for providing the intake port 67. The filter 64 is a nonwoven fabric made of charged polypropylene fibers, and collects UFP guided to the filter 64 by an electrical adsorption force due to electrostatic charges applied to the fibers and a physical blocking force of the fibers. As the fiber density of the filter 64 increases, the reducing power of UFP by the filter 64 can be increased.

The exhaust port 69 as a second exhaust port exhausts air sucked and taken into the second duct 71 via the intake port 72 by the second duct fan 61 to the outside of the image forming apparatus 200.

The frame member 70 is provided around the intake port 67 and the intake port 72. The filter 64 is attached to the frame member 70.

The second duct 71 connects the intake port 72 and the exhaust port 69. The second duct 71 constitutes a second ventilation passage that guides air sucked from the intake port 72 to the exhaust port 69.

The intake port 72 as the second intake port is covered with the filter 64 attached to the frame member 70. The intake port 72 is provided on the fixing belt 27 side with respect to the conveyance path 12 of the sheet S between the secondary transfer roller 16 and the fixing device 119. The intake port 72 is provided adjacent to the intake port 67. The intake port 72 takes air between the fixing device 119 and the intermediate transfer belt 9 sucked by the second duct fan 61 and air (air B) between the fixing device 119 and the secondary transfer roller 16 into the second duct 71.

In the second duct unit 63 having the above configuration, the air taken in from the intake port 72 via the filter 64 passes through the second ventilation passage indicated by an arrow of the one-dot chain line in FIG. 15B and is exhausted from the exhaust port 69. The second duct fan 61 and the filter 64 are disposed in the second ventilation passage.

### Operations of First Fan, First Duct Fan, and Second Duct Fan

Operations of the first fan 55, the first duct fan 62, and the second duct fan 61 of the image forming apparatus 200 according to Embodiment 2 of the present invention will be described in detail with reference to FIGS. 12 to 17.

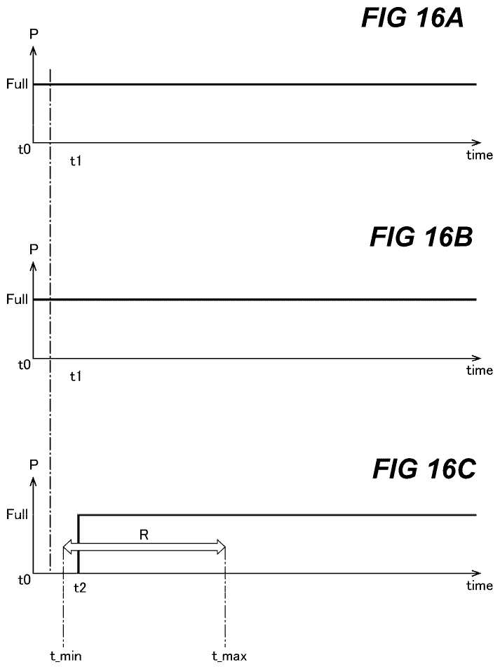

In FIGS. 16A to 16C, FIG. 16A illustrates the operation time of the first fan 55, FIG. 16B illustrates the operation time of the second duct fan 61, and FIG. 16C illustrates the operation time of the first duct fan 62. In FIGS. 16A to 16C, time on the horizontal axis represents time, and P on the vertical axis represents power when each fan is operated.

Since the first duct fan 62 is provided to discharge water vapor and the second duct fan 61 is provided to remove UFP, the first duct fan 62 and the second duct fan 61 need to be operated, respectively. The first duct unit 66 does not include a ventilation resistor such as a filter in order to secure an air volume. Therefore, the air volume of the first duct unit 66 is about 3 times the air volume of the second duct unit 63 including the filter 64.

Most of the UFP inside the image forming apparatus 200 is discharged to the outside of the image forming apparatus 200 by the first duct unit 66 without passing through the filter 64 while the first duct unit 66 is in operation. Therefore, in the present embodiment, in order to ensure the removal of the UFP by the filter 64, the timing at which the first duct fan 62 starts to operate is delayed from the timing at which the second duct fan 61 starts to operate.

Specifically, the first fan 55 and the second duct fan 61 start to operate at full power at time t0 when the temperature control of the fixing belt 27 is started before the conveyance of the sheet S is started. The first fan 55 operates to collect and discharge water vapor floating on the downstream side in the conveyance direction of the fixing device 119. The second duct fan 61 operates to cause the filter 64 to collect the UFP generated by the fixing device 119.

The first duct fan 62 stops operation from time t1 at which sheet passing is started to time t2, and operates at full power after time t2. Here, time t2 is a time when the conveyance distance of the sheet S from the time when the tip end portion of the sheet S in the conveyance direction passes through the fixing nip portion N reaches 9,450 mm as a first predetermined value after the temperature adjustment is started. The timing of starting the operation of the first duct fan 62 is later than that in Embodiment 1 described above in which the second fan 56 is operated when the conveyance distance of the sheet S from the time when the tip end portion of the sheet S in the conveyance direction passes through the fixing nip portion N reaches 2,100 mm. As a result, the UFP reduction effect by the filter 64 can be improved as compared with Embodiment 1 described above.

The timing of operating the first duct fan 62 is not limited to the above, and may be any timing other than the above as long as it is within the time R from time t_min to time t_max in FIG. 16C. Even in this case, a sufficient UFP reduction effect and dew condensation prevention effect can be obtained. Here, time t_min is a time when the conveyance distance of the sheet S from the time when the tip end portion of the sheet S in the conveyance direction passes through the fixing nip portion N reaches 660 mm. Further, time t_max is a time when the conveyance distance of the sheet S from the time when the tip end portion of the sheet S in the conveyance direction passes through the fixing nip portion N reaches 12,600 mm.

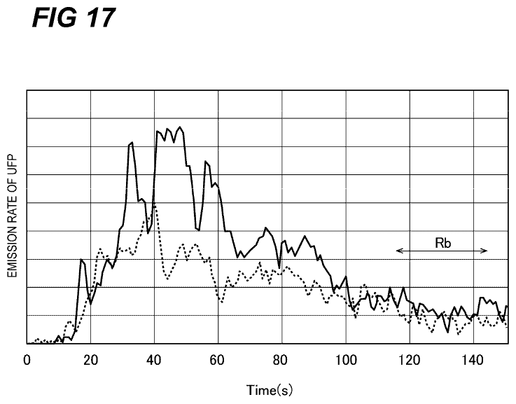

FIG. 17 is a comparison of the transition of the UFP emission rate between when the first duct fan 62 is operated from time t0 and when the first duct fan 62 is operated from time t2. The time t2 is exemplified here as approximately 52 seconds. In FIG. 17, the broken line indicates the transition of the UFP emission rate when the first duct fan 62 is operated from time t0, and the solid line indicates the transition of the UFP emission rate when the first duct fan 62 is operated from time t2.

From FIG. 17, it can be seen that the UFP emission rate when the first duct fan 62 is operated from time t2 is lower than the UFP emission rate when the first duct fan 62 is operated from time t0. Further, in the region of Rb in FIG. 17, which is a time point when a certain period of time has elapsed, the periphery of the fixing device 119 is warmed, and thus the UFP can be reduced by operating the first duct fan 62. As described above, immediately after the start of sheet passing in which a large amount of UFPs is generated, the UFP is stably removed by the filter 64. Thereafter, UFPs can be significantly reduced by the synergistic effect of the UFP reduction effect due to the operation of the first duct fan 62 and the UFP removal effect of the filter 64.

Further, since the second duct fan 61 is operated before the first duct fan 62 is operated, water vapor between the fixing device 119 and the intermediate transfer belt 9 is sucked from the intake port 72 of the second duct unit 63 and discharged from the exhaust port 69. Therefore, before the operation of the first duct fan 62, the concentration of water vapor increases but is gentle, and thus dew condensation on the intermediate transfer belt 9 can be suppressed.

In addition to the operation of the second duct fan 61, the first duct fan 62 is operated when the conveyance distance of the sheet S reaches 9,450 mm, and thus dew condensation on the intermediate transfer belt 9 can be reliably suppressed.

The first duct fan 62 may perform the above operation when the temperature detected by the in-machine temperature sensor 65 is 10° C. or higher and 30° C. or lower. On the other hand, when the temperature detected by the in-machine temperature sensor 65 is higher than 30° C., the generation amount of UFP is small and dew condensation hardly occurs, and thus the operation of the first duct fan 62 and the operation of the second duct fan 61 can be stopped. Accordingly, power saving can be achieved. On the other hand, when the temperature detected by the in-machine temperature sensor 65 is lower than 10° C., it is preferable to operate both the first duct fan 62 and the second duct fan 61 from time t0 with priority given to dew condensation prevention affecting image quality.

In addition, the conveyance distance of the sheet S from when the tip end portion of the sheet S in the conveyance direction passes through the fixing nip portion N is reset when a predetermined condition is satisfied. For example, when the image forming operation is interrupted for a certain period of time and the temperature detected by the in-machine temperature sensor 65 decreases to a predetermined temperature or lower, the generation amount of UFP increases. In such a case, when the conveyance distance of the sheet S is not reset, the stop time of the first duct fan 62 is shortened. Therefore, in such a case, the control circuit portion A resets the count value counted as the conveyance distance of the sheet S from when the tip end portion of the sheet S in the conveyance direction passes through the fixing nip portion N.

Furthermore, the conveyance distance of the sheet S from when the tip end portion of the sheet S in the conveyance direction passes through the fixing nip portion N when the first duct fan 62 starts to operate may be changed depending on the type and productivity of the sheet S. For example, the conveyance distance of the sheet S from when the tip end portion of the sheet S in the conveyance direction passes through the fixing nip portion N is set to a small value because more water vapor is generated when the sheet S is a thick sheet containing a large amount of moisture or when the productivity of the sheet S is high.

As described above, in the present embodiment, the UFP can be stably removed by the operations of the first duct fan 62 and the second duct fan 61, and dew condensation on the intermediate transfer belt 9 can be suppressed. Thus, the image forming apparatus 200 of the present embodiment is suitable in a case where the generation amount of UFP is large due to the high temperature of the fixing belt 27, and in a case where dew condensation on the intermediate transfer belt 9 is to be suppressed.

The second duct unit 63 includes the filter 64 that can stably reduce the UFP regardless of the temperature and the concentration, and thus the second duct unit 63 can stably reduce UFPs.

Since the operation of the image forming apparatus 200 is the same as the operation of the image forming apparatus 100, the description thereof will be omitted.

In the present embodiment, when the transfer operation is started, the operation of the first duct fan 62 is started when the conveyance distance of the sheet S passing through the fixing nip portion N reaches 9,450 mm. As a result, it is possible to achieve UFP reduction, heat exhaust, and water vapor discharge.

In addition, by providing the intake port 67 and the intake port 72 adjacent to each other, the image forming apparatus 200 can be downsized.

In the present embodiment, the first duct fan 62 is operated according to the conveyance distance of the sheet S from when the tip end portion of the sheet S in the conveyance direction passes through the fixing nip portion N. However, the present invention is not limited thereto, and the first duct fan 62 may be operated according to the total area of the sheet S that passed through the fixing nip portion N. In this case, although the arithmetic processing becomes somewhat complicated, the amount of water vapor generated from the sheet S has a correlation with the total area of the sheet S, which is reasonable from the viewpoint of preventing dew condensation.

In the present embodiment, the second duct fan 61 is operated from time t0, but the present invention is not limited thereto, and the second duct fan 61 may be operated several seconds later than time t1 or at time t1 which is the sheet passing start time. Even in this case, since the generation amount of UFP is not so large before the start of sheet passing or immediately after the start of sheet passing, a sufficient UFP reduction effect can be obtained.

Note that, in the present embodiment, the operation of the first duct fan 62 according to only the conveyance distance of the sheet S after the tip end portion of the sheet S in the conveyance direction is detected by the detection sensor 25 may be controlled. For example, the operation of the first duct fan 62 is started when the conveyance distance of the sheet S reaches 2,100 mm as a second predetermined value, which is less than 9,450 mm, after the tip end portion of the sheet S in the conveyance direction is detected by the detection sensor 25. In this case, by setting the second predetermined value such that the value obtained by adding the distance from the fixing nip portion N to the detection sensor 25 to the second predetermined value is 660 mm or more and 12,600 mm or less, it is possible to achieve both UFP reduction and dew condensation prevention.

It goes without saying that the present invention is not limited to the above embodiment, and various modifications can be made without departing from the gist of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2024-93482, filed Jun. 10, 2024 and Japanese Patent Application No.2025-31439, filed Feb. 28, 2025, which is hereby incorporated by reference herein in its entirety.

What is claimed is:

1. An image forming apparatus capable of executing a continuous job of forming an image on a plurality of pieces of recording material, the image forming apparatus comprising:
an image forming unit that forms a toner image using a toner containing a release agent;
a transfer unit that performs a transfer operation of transferring the toner image formed by the image forming unit to a recording material;
a fixing unit that includes a first rotating member that is heated by a heating unit and a second rotating member that abuts against the first rotating member and forms a fixing nip portion together with the first rotating member, and fixes the toner image to the recording material by nipping and conveying the recording material to which the toner image is transferred by the transfer unit at the fixing nip portion;
a first duct unit including a first intake port that sucks air between the fixing unit and the transfer unit, a first exhaust port that exhausts air sucked from the first intake port to an outside, and a first duct that forms a first ventilation passage between the first intake port and the first exhaust port;
a first duct fan that is provided in the first ventilation passage and generates an air flow from the first intake port toward the first exhaust port;
a second duct unit including a second intake port that sucks air between the fixing unit and the transfer unit, a second exhaust port that exhausts air sucked from the second intake port to the outside, and a second duct that forms a second ventilation passage between the second intake port and the second exhaust port;
a second duct fan that is provided in the second ventilation passage and generates an air flow from the second intake port toward the second exhaust port;
a filter that is provided in the second ventilation passage and removes fine particles; and
a control unit that controls operations of the first duct fan and the second duct fan, wherein
in a case where a continuous job is started, the control unit starts the operation of the first duct fan when a conveyance distance of a recording material passing through the fixing nip portion reaches a first predetermined value.

2. The image forming apparatus according to claim 1, wherein
the control unit operates the second duct fan before start of conveyance of the recording material.

3. The image forming apparatus according to claim 1, wherein
the first intake port is provided adjacent to the second intake port.

4. The image forming apparatus according to claim 3, wherein
the first intake port is provided in a central portion in a rotation axial direction of the first rotating member.

5. The image forming apparatus according to claim 1, further comprising:
a temperature detection unit that detects a temperature around the fixing unit, wherein
when the temperature detected by the temperature detection unit is 10°° C. or more and 30° C. or less, the control unit starts an operation of the fan when a conveyance distance of the recording material passing through the fixing nip portion reaches the first predetermined value.

6. The image forming apparatus according to claim 1, wherein
the first predetermined value is 660 mm or more and 12,600 mm or less.

7. The image forming apparatus according to claim 1, further comprising:
a recording material detection unit that detects a recording material on a downstream side of the fixing nip portion in a conveyance direction of the recording material, wherein
the control unit starts an operation of the first duct fan when a conveyance distance of the recording material after the recording material detection unit detects the recording material reaches a second predetermined value which is less than the first predetermined value.

8. The image forming apparatus according to claim 1, wherein
the first intake port is provided on the first rotating member side with respect to a conveyance path of the recording material from the transfer unit to the fixing unit.

9. The image forming apparatus according to claim 1, wherein
the first duct does not include a ventilation resistor in the first ventilation passage.

10. The image forming apparatus according to claim 1, wherein
the control unit varies the first predetermined value in accordance with a type of the recording material.

11. The image forming apparatus according to claim 1, further comprising:
a temperature detection unit that detects a temperature around the fixing unit, wherein
the control unit varies the first predetermined value in accordance with the temperature detected by the temperature detection unit.
